(19) United States
(12) Patent Application Publication
(10) Pub. No.: US 2003/0119570 A1
(43) Pub. Date: Jun. 26, 2003

(54) Gaming apparatus and gaming method

(76) Inventor: Dean G.A. Maroun, Randjiesfontein (ZA)

Correspondence Address: Dicktein Shapiro, Morin& Oshinsky, 41st Floor, 1177 Avenue of the Americas, New York, NY, 10036-2714, US

(21) Appl. No.: 10/203,380

(22) PCT Filed: Feb. 12, 2001
(86) PCT No.: PCT/ZA01/00015

(51) Int. Cl. G06F 17/00

(52) U.S. Cl. 463/6

(57) ABSTRACT

This invention relates to gaming apparatus and a gaming method More particularly, but not exclusively, this invention relates to horse race gaming apparatus and a method of simulating horse races. The apparatus consists of storage means for storing a number of computer generated racing objects. Each of the racing objects have inherent attributes assigned by a computing means. Receiving means receives race performance influencing information before the start of a race and the computing means simulates a race between at least two racing objects. An outcome of the race is computed using at least some of race influencing information and the inherent attributes of the racing objects.

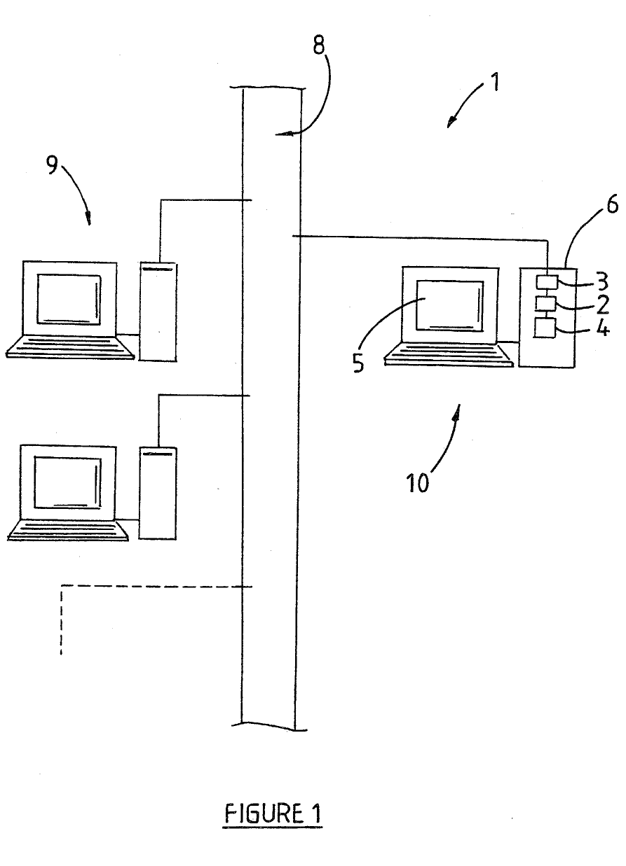

### FIELD OF THE INVENTION

This invention relates to gaming apparatus and a gaming method and more particularly, but not exclusively, to horse race gaming apparatus and a method of simulating horse races.

### BACKGROUND TO THE INVENTION

Computer generated racing games are known through disclosures such as the simulated racing game disclosed in U.S. Pat. No. 5,186,460. The racing game disclosed in this patent document is a computer simulated racing game and the outcome of a simulated race is computed through inputs provided by players as well as by a random number generator. A reserve of energy is allocated to each contestant. A rate of energy consumption is determined through inputs from players. A player can influence only directional moves and speed of contestants. These player inputs determine the rate of energy consumption of each contestant.

Contestants can have different track attributes stored in an array for each contestant. Some contestants can be assigned a dry track attribute, others a mud track attribute. A contestant on a preferred track will be assigned more energy or more “speed tokens” for use by a player.

U.S. Pat. No. 5,823,872 discloses a simulated racing game in which lateral and forward movement of tokens towards a finish line is determined by a random number generator. Players may make bets on the outcome of a race. The tokens all have an equal chance of winning a race and are not assigned inherent attributes.

Patent Co-operation Treaty international application number PCT/AU93/00628 published under international publication number WO 94/13374 discloses a randomly generated animated racing game. Each participant in each race has a statistically equal change of success and the outcome of a race is determined by a random number generator.

Patent Co-operation Treaty international application number PCT/AU98/01029 published under international publication number WO 99/30788 discloses a computer based animated racing game where moves of each competitor is determined by a random number generator. Each competitor thus has an equal chance of winning a race. The competitors are all equal and do not have inherent qualities or talents or attributes that will place some competitors to an advantage above others in a particular race.

### OBJECT OF THE INVENTION

It is an object of this invention to provide gaming apparatus and a gaming method.

### SUMMARY OF THE INVENTION

In accordance with this invention there is provided gaming apparatus comprising storage means for storing a number of computer generated racing objects, each racing object having inherent attributes;

receiving means for receiving racing object race performance influencing information before the start of a race; and

computing means for simulating a race between at least two racing objects and computing an outcome of the race using at least some of the race influencing information received and the inherent attributes of the racing objects.

There is provided for the inherent attributes to be randomly generated by the computer means, and to be assigned to each racing object by the computing means.

Alternatively, there is provided for the inherent attributes of one racing object to be computed from at least the inherent attributes of two other racing objects and/or from a history, including a previous racing performance history of the two other racing objects, and/or a random factor.

There is provided for the outcome of a race to be computed from race condition information.

A further feature of the invention provides for the race condition information to be randomly generated by the computing means.

Further features of the invention provide for the race condition information to include track condition information and weather condition information; for the race condition information to be computed before simulating a race; for the race condition information to be transmitted to be made available to participants before the start of a race.

There is further provided for the computing means to simulate different races at different times, for the computing means to simulate races on different tracks, for the computing means to simulate different lengths of races.

Still further features of the invention provide for the racing object race performance influencing information to include information relating to equipment used or not used by a racing object for a race; special equipment used by a racing object in a race, the previous training performance or frequency of a racing object and/or the previous racing performance of a racing object, and feed supplements used by a racing object where the racing object is a simulated animal.

There is further provided for at least some of the race performance influencing information to enhance or suppress inherent attributes.

There is also provided for at least some of the race performance influencing information to be used by the computing means to compute a performance index for a racing object.

There is provided for the computing means to compute the performance index for a racing object from at least some of the racing object race performance influencing information.

A yet further feature of the invention provides for the performance index to be calculated from the previous training performance or frequency and/or racing performance or frequency of a racing object and, in the case of the racing object being a simulated animal, a feeding or feed supplement history or amount of feed supplement used by the simulated animal.

A further feature of the invention provides for the outcome of a race to be computed from some of the following:

the performance index, from some of the racing object performance influencing information, the inherent attributes of the racing object, race conditions of a race, and a random performance factor generated for each racing object in each race.

This invention extends to a gaming method comprising the steps of:

storing a number of computer generated racing objects, each racing object having inherent attributes;

receiving race performance influencing information before the start of a race;

simulating a race between at least two racing objects; and

computing an outcome of a racing using at least some of the race influencing information received and the inherent attributes of the racing object.

These and other features of the invention are described in more detail below.

### BRIEF DESCRIPTION OF THE DRAWING

Preferred embodiments of the invention are described below, by way of example only, and with reference to the accompanying drawing which shows a schematic diagram of gaming apparatus.

### DETAILED DESCRIPTION OF THE DRAWING

The particular embodiment described herein is for horse race gaming apparatus and a horse race gaming method. It will be appreciated by those skilled in the art that the invention is not limited to a horse racing game. The game can also relate to dog racing, motor racing, boat racing or any kind of racing game where racing objects can be simulated by a computer program.

With reference to the drawing, gaming apparatus for simulating a racing game is generally indicated by reference numeral 1.

The apparatus 1 consists of a memory means 2 (also referred to as storage means), communication means 3 and computing means 4 housed in a housing 6 of a host computer 10. A display means 5 in the form of a computer monitor is connected to the host computer 10. The communication means 3 is connected to a computer network such as the Internet 8.

The host computer 10 hosts a website for members to participate in the game. The host computer 10 is connected to the Internet as is known in the art through an Internet service provider.

Remote personal computers 9 are connected to the Internet through service providers as is known in the art.

Data relating to a number of simulated racing objects are stored on the memory means 2. In this embodiment, the simulated racing objects are horses which are generated by the computing means 4 to provide a number of “virtual” horses.

The data stored on the memory means 2 includes a number of simulated horses. Each simulated horse has randomly generated attributes. Thus, some horses may be better suited for racing on wet tracks than on dry tracks whilst others or the same horses may be better suited for racing in longer races than in short races. It will be appreciated by those skilled in the art than the number and combinations of attributes that can be assigned to a horse are numerous.

Further examples of attributes that can affect a horse's performance include inherent attributes regarding racing with or without blinkers and with aluminium shoes or with steel shoes. All these attributes are programmed on a random basis and assigned to the “virtual” or simulated horses.

The data stored on the memory means 2 may also include a history of sale prices including a last sale price obtained for the horse and the age of the horse.

Input data is also stored on the memory means. The input data is downloaded from the Internet 8 through the communication means 3 and stored on the memory means 2. Input data is downloaded by participants for their specific horses as described in more detail below. The input data may include a training program for a horse the horse's result in previous races, a diet for a horse, the identity of a simulated trainer for a horse and the identity of a simulated place of residence of a horse, or the products that have been applied to that horse (described below). It is envisaged that input data will be selected by a participant from a number of choices on menus on the website. The input data thus includes race performance influencing information as described further below. The race performance influencing information also includes previous race and barrier race performances and a frequency of participation therein. This information is determined by participants (or owners) and is received or used for computing an outcome of a race.

Participants are also referred to in this specification as “members”. Members are classified into owners and bettors.

Owners can buy virtual horses, name their horses, choose silks for their horses, train their horses, enter their horses in races, sell their horses, breed with their horses and bet on horses in races. Owners can have an influence on the outcome of races depending on race performance influencing information provided by owners. An owner can influence an outcome of a race by choosing that this horse will or will not use certain equipment during a race. An owner can also choose to use special equipment. Special equipment may include a better quality horse shoe such as lighter aluminium horse shoes rather than steel ones.

An owner can also influence a race by training a horse and feeding the horse supplements.

Some of the race performance influencing information provided by an owner can influence gauge or performance index of a horse. For example, training the horse will increase the performance index of the horse. So will feeding the horse supplements. However, over training and too much supplements will adversely affect the performance index.

By racing a horse in barrier races as described below, an owner can determine at least some of the inherent attributes of a horse. For example, if a horse has an inherent attribute for racing with blinkers rather than without, this can be determined by experimentation in barrier races. Race performance influencing information such as racing with or without blinkers can thus enhance or suppress inherent attributes of a horse and influence the outcome of a race.

Bettors can only bet on races and have no influence on the outcome of races. Bettors do not own and train horses for races.

The communication means 3 includes an Internet modem for connection to the Internet 8. A website is provided by the host computer 10 for access by members through their personal computers 9 over the Internet. A member, when the website is accessed over the Internet 8, chooses from a menu which includes choices such as buying a horse, betting on a race, training, the training location and the diet of a horse. A member can also choose to enter a race, sell a horse or breed horses.

The owner provides input information relating to these choices and this information is stored on the memory means 2 of the host computer 10.

At the start of the game a number of horses with previously recorded inherent attributes stored in the memory means 2 will be offered for sale on the website. Later on, new horses will be “bred” by owners of stallions and broodmares.

Member may buy their own horses and determine the training, training location and diet of their horse and products applied to their horse. A training and/or training facility may also be chosen. Members may also enter races, breed horses or sell horses.

Horse owners and bettors may place bets on horses for races simulated by the computing means 4. The placing of bets will be in accordance with real-life betting systems and schemes.

At predetermined times or on request from a minimum number of participants, the computing means 4 will simulate a race between a number of competing horses. A race result is computed by the computing means 4 according to a predetermined formula and may be based on some of the following:

the performance index of a horse, the racing object race performance influencing information, the inherent attributes of the racing object, race conditions and a random influence. All of these may also have inter-related influences on each other. The race result is made accessible on the Internet 8 through the communication means 3.

The computing means 4 also randomly generates race condition information. The race condition information includes track condition, such as wet or dry track, and weather information for a race. This information is provided to members before a race.

The computing means simulates races and predetermined times or on request as stated above. The computing means can schedule different lengths of races, different tracks, such as grass or sand, and different categories of races, such as novice races.

Prior to simulating a race, betting information will be available to members and received from members through the communication means 3 over the Internet 8. The betting information from members will be stored in the memory means 2 and a betting result will be calculated from the betting information and the race result by the computing means 4.

It is envisaged that the apparatus described herein will provide a virtual racehorse industry on the Internet. Horses can be bought and sold and their training programs can be altered by owners. The diet of a horse is also determined by owners. Owners can enter races, sell their horses and breed horses with the co-operation of other members or buy their own horses for breeding purposes as in a real live horse industry. Bettors and owners can place bets on races as in real live.

Members will pay for all choices and activities and will also pay for entering races. Food and stabling and maybe also transport would have to be paid for.

The virtual horses created by the computing means and stored on the storage means will build up a racing and breeding history and thus also a boodline which will all be stored on the storage means and available to members.

The age of a horse may also be taken into account, and may thus also influence a race result computed by the computing means 4.

A specific non-limiting embodiment of the invention is now described below.

The game will be available for participation over the Internet. An operator will host a website including a number of web pages for taking part in the game. Web pages are referred to as “web pages” or just “pages”. The pages include “buttons” or “hyperlinks” for the selection of options by members or perspective members by “clicking” on these buttons.

To become a bettor or a horse owner, all a prospective member needs to do is click on a register button, which appears at the top of every page. This will link a prospective member to a registration page. The prospective member enters his personal details and his credit card details. Credit card details are encrypted and stored in a database.

Once successfully registered, the member can log in by accessing a login page. The login page is accessible in two ways. Either by clicking on a login button that appears at the top of each page or by attempting to access a page that is only available to members. Once a member accessed the login page a valid email address and password combination has to be provided.

Once the member is logged in he will either be directed to a personalised home page or the page he was trying to access when he was directed to the login page.

In order to wager on any race or purchase a horse, credits must be deposited into a secure account. In order to prevent fraud, basic contact information and financial information must be provided to become a member. Contact information is used to contact a member when necessary. A member can elect not to receive any information regarding the operator.

Members have the opportunity of owning their very own virtual horse or horses. Members can race their horses against other horses for real prize money. After earning stakes money, a horse is still capable of generating even more revenue as part of a breeding program, as either a broodmare or a stallion. A broodmare is guaranteed to produce live and sound foals that a member can either keep and race for himself, or sell at auction for real money. A stallion is eligible to service up to 50 mares a season and for each of these services the member will receive a fee, determined by him, that is payable in real money.

Members can also make money by placing wagers on virtual races. Every horse has past form, and analysing this form will increase the likelihood of a bet being successful. As with real horseracing, handicapping these horses is a skill that can pay handsomely.

There are two ways for a horse to earn money. The first is the horse's racing career. Each time it competes against other horses in a stakes race or a championship race it will be for various sums of prize money. The more races it wins or places in, the more money his owner makes. The second is when the horse's racing career finishes and it becomes eligible to breed with other horses. The owner of a stallion can charge a fee for each mare that is serviced. There is a limit of 50 mares that a stallion may service per season, but there is no limit as to what a member can charge for each service provided of course that there are other owners who wish to use a stallion for their mares. The owner of a mare, will own the foals that she produces. The foals may be raced by the owner himself in his own colors or the owner may auction them, setting his own reserve price, in a virtual sales ring.

The stakes money in every stakes race will be distributed to the first four finishers in any given stakes race, according to the following percentages. The first-placed horse receives 50% of the total stakes money. The second-placed horse receives 25% of the total stakes money. The third-placed horse receives 15% of the total stakes money. The fourth-placed horse receives 10% of the total stakes money. If there are only three horses in the race, the stakes will be divided as follows: The first-placed horse receives 60% of the total stakes money. The second-placed horse receives 25% of the total stakes money. The third-placed horse receives 15% of the total stakes money. If there are only two horses in the race, the stakes will be divided as follows. The first-placed horse receives 75% of the total stakes money. The second-placed horse receives 25% of the total stakes money.

Nomination fees are paid for entering a horse in a race. Nomination fees that are received determines the total stakes money available for every stakes race. Therefore, a maiden stakes race with a final field of 12 horses will be worth more money than a maiden stakes race with a final field of only 3 horses. Every type of stakes race has its own set nomination fee. This is the cost to enter one horse in that race. If the horse is accepted into that race, then owners will be charged that nomination fee. To determine the purse for a race, a member can multiply the number of entries with the nomination fee and subtract a 15% administrative charge. The operator has no vested interest in the outcome of any of its races. The operator offers races to its members as a service and charges an administrative fee in order to facilitate that race and other services. This administrative fee is a guarantee to members that all races are fair.

All pages on the website which contain confidential information are secure, for example, the pages in a cashier section which display a member's account details. These secure pages are accessible through a Secure Sockets Layer (“SSL”) connection; a padlock on the bottom right hand side of some pages verifies this. The SSL connection ensures that any transactions processed are secure. Credit card details are also encrypted and stored in a database.

The operator schedules races in advance. Race start times are based on GMT. All start times for races are displayed in GMT. Members can tell what adjustment they need to make for different time zones by looking at the time zone box in the top right hand corner of the home page, and clicking on the link for time zone differences. This will direct a member to a time zone page, which will allow him to select his region from the drop down menu. Once this has been done, the time zone box on every page will display the adjustment that a member needs to make to calculate the start times in his part of the world. The time zone box also displays the adjustment, if any, that he will need to make for daylight savings time. The default region featured in the time zone box when a member first visits first visit the site is “USA Eastern”.

The outcome of every race is determined by an algorithm that takes into account a series of factors, including:

The inherent abilities of each horse in that race (also referred to as “attributes”),

The various external conditions for that race (such as the track condition for that day and where each horse is drawn on the track),

The overall well being (or gauge) of the horse, which is determined or influenced by the owner.

Each horse on the system is created with the same set of characteristics, however the values of each of these characteristics will differ for every horse.

Therefore, every horse will have its own unique combination of values, ensuring that they all have different abilities (attributes). For every horse generated on the site, the following characteristic or attribute set is produced:

Innate ability rating at 2 years (based on a normal distribution)

Innate ability rating at 3 years (this is a random increase from the 2 year old rating)

Innate ability rating at 4 years (this is a random increase from the 3 year old rating)

Stamina rating (for each distance. Every horse thus has optimum distances and distances over which it will be weaker)

Gelding (for male horses only. A procedure that affects performance—a different impact on each horse)

Alumites (shoes that affect performance—a different impact on each horse)

Blinkers (equipment that affects performance—a different impact on each horse)

Track rating (For each track type and track going combination. For example, a horse receives a rating for how it will perform on a dirt track with fast going, or on a turf track with yielding going)

All characteristics are expressed as a percentage. Each characteristic is also weighted differently, which determines its importance relative to all the other characteristics. Therefore, for example, the impact that alumites has on a horse will be less important than the characteristic of stamina.

A large number of these characteristic sets are produced by randomly pulling values from normal distributions. When a member purchases a horse he is assigned an identification that uniquely identifies a characteristic set. This characteristic set will have an influence on the performance of a horse in any given race.

To determine the result of a race the computing means does the following for each horse that participates:

Retrieve all the relevant attributes of that horse. Multiply each attributes with its weight.

Draw a random number from a uniform distribution. Multiply this random number with the weight allocated for randomness as factor in the race.

Add up all the characteristics including this random affect.

The owner influence is also the taken into account, i.e. the race performance influencing information. Furthermore, race conditions are taken into account as well as the effect of race performance influencing information on the attributes of a horse.

The horse with the highest rating will finish first, second highest is second etc. the system does not allow ties, and in the event of a tie another random sequence is generated to separate the two or more horses involved.

An audit trail exists for every race, so that the data used to generate a race can be reviewed. All data is securely stored, and certain information that owners possess regarding their own horses (such as overall fitness of their horses, and their performances in barrier races) is strictly confidential, and is made known only to them. Barrier races are described in more detail below.

As with real horseracing, every race has an element of unpredictability that is built into the race algorithm (using a complex random number generator), ensuring that the outcome of each race cannot always be predicted with accuracy. There is a high level of skill involved in successfully owning a horse, or betting on one. An owner's skill will make a difference to his horse's performance, but he will still need some luck to be on his side. It is this intangible factor that makes this game uniquely exciting and challenging and comparable with live racing.

All horses celebrate birthdays on March 1, July 1 and November 1 of the calendar year. Therefore, in the space of a twelve-month period they age three virtual years. Once they turn 5, all horses are automatically retired from racing, and provided they are not inactive they can be used for breeding. A member keeps his horse active by paying a monthly subscription fee.

On the day that every horse turns 5 it is automatically retired. Provided that it is not a gelding, and a monthly subscription fee is still paid, the horse may begin the second phase of its career, namely breeding.

Colts are now referred to as stallions and fillies are now referred to as broodmares. Owners of stallions determine the amount they wish to charge for their stallion's service. The owner of a mare then decides to breed with that stallion, agrees to the price of that service, and purchases what is known as a stallion season. This sale is administered and approved by the operator who receives and pays out all credits involved in the breeding process. The innate abilities (attributes) of the stallion and the mare will be used to create a series of new algorithms, which, in conjunction with a randomly generated component, will represent the abilities (attributes) of their offspring. A healthy foal is guaranteed and immediately produced, and the owner of the mare will then be allowed to sell that foal in an auction to be held in the sales ring. Alternatively, the owner of the foal can enter it in races. All sales of horses in accordance with the above procedure will be administered and approved by the operator.

As soon as a member buys a horse, he becomes a horse owner. A member can buy a horse from anywhere on the website by clicking on a ‘buy a horse’ button on the left hand navigation bar, or any ‘buy a horse’ button on the home page. The buy a horse page allows a member to select a horse's color and sex, and enter a name for his horse. When buying a horse, the system allocates a horse to the owner. The horse is created by the system with a randomly generated racing ability (attributes). If a member is a first time horse buyer, he will be directed to a silks designer page, otherwise he is directed to a tack shop page. The silk designer page allows the member to dynamically design his own unique silks. Once his silks have been successfully created, he is directed to the tack shop page, which allows him to purchase products for his horse. These products may help improve the racing performance of his horse. All items purchased, including the horse, and silks for a first time buyer, are placed in an owner's basket. A member can do all this without being logged on to, or even registered with, the site. A member can pay for his items at any stage by clicking on the button marked “purchase”. At this stage, however, the member must log onto the site, or register if not already registered as a member. Once there has been successful registration and logging in, the transaction is processed. If this is successful, the member becomes the owner of a horse.

All two-year old horses can be purchased by going to a sales ring page. For the first calendar year of operation of the game, all two-year olds will be sold at one standard price since the abilities of these horses are randomly generated. All horses thus have inherent programmed abilities or attributes which makes them “unequal” in races.

As no one knows what these abilities are, it is unfair to charge different prices for these horses. However, when the sales ring offers two-year-olds that are the result of owners breeding with their or other stallions and mares, then the prices will all be different as determined by owners. These horses will have abilities largely based on their parents' abilities and racing history and prices will vary accordingly.

As a general rule fillies will have lower abilities than their male counterparts, although there will be fillies that will be able to beat colts. However, the majority of races that are available are for fillies only or for colts and geldings only. These races will carry identical nomination fees, so the prize money available can be the same depending on the number of entries. A filly will generally race against other fillies. Furthermore, once a filly retires from racing and becomes a broodmare she is guaranteed to produce live and healthy foals all of whom will belong to the owner. This means that a member's filly will ultimately provide him with the potential to make money as a breeder.

The primary reason for buying a colt is that if a member is fortunate enough to purchase a champion then he is well on the way to a healthy income for the next three actual years. Not only does his horse earn stakes money while it races, but it should be in demand as a stallion once it retires. All colts that have not been gelded automatically become stallions.

The jacket and cap worn by the jockey that rides a horse are referred to as “silks”. The colors and design of each jacket are unique to each owner. The cap color will designate the post positions or draw of the horses (e.g. the horse drawn one will always wear a yellow cap, the horse drawn second will always wear a red cap, etc.). The jacket, however, is designed by the owners themselves upon their first purchase of a horse at a silks designer page. This silk design will be each owner's personalized crest or icon for the game.

The silks will enable both the owner and fellow members to identify specific horses in races.

Once an owner has successfully selected a colour, sex and name for his horse, he will be directed to the silk designer page.

An owner chooses a design from the top panel of a designs block on the silk designer page. An owner generates his own colors by clicking a color in a color palette block on the silk designer page, and clicking a section on his design. This is repeated until the silks have been custom-designed to the owner's taste. Alternatively, an owner can click on one of the silks in a bottom panel that displays color combinations for that specific design that are still available on the site. To display more available silks in the bottom panel, the owner can continue clicking the design in a top panel. Once an owner selected silks, he must click a “save” button to save the silks to the database or “cancel” to go back to the buy a horse page.

If a horse is eligible for a race, the nomination will be added to the owner's basket. An owner must access his basket to pay his nomination fee and confirm his horse's entry in that race. The owner will then be sent an email confirming his horse's participation in that race. If an owner nominates his horse in advance, and in the interim his horse becomes ineligible for that type of race (e.g. he nominates his horse for a maiden stakes race a week in advance, and in that preceding week his horse wins another maiden stakes race), he will be sent an email informing him of this, and his nomination will be refunded in credits.

An owner can nominate a maximum of 4 of his own horses for any one race. He must then pay the nomination for each horse in that race.

Owners are allowed to race their horse 12 times in one calendar month. This may however change in future. Any owner may therefore, successfully nominate his horse 12 times in any given month. However, horses may also only race for prize money a maximum of once a day, that is, between 00:00 hrs (GMT) and 23:59 hrs (GMT) of any calendar day.

Nominations close exactly one hour before the scheduled start time of any stakes race. For example, if a race is scheduled to take place at 13:00 hrs GMT, then an owner may nominate his horse for that race up until 11:59 hrs GMT. Owners may also nominate for races up to one month in advance.

Races have set conditions that determine which horses can compete against each other in that race. For example, there are races only for horses that have never won a race (maiden stakes races), and races for horses that have won either one or two previous races (novice stakes races). There are races that are only for horses of a certain age, and races that are only for horses of a certain sex. If an owner's horse becomes ineligible for a race that it was previously eligible for, before that race is actually run, the horse will be scratched from that race and the nomination fee will be refunded in credits.

All stakes races, other than championship races held on a championship race day require nominations. Qualifying stakes races for the championship races do require nominations, because these are normal stakes races where, in addition to the prize money, points can also be earned to qualify a horse for the actual championship race. Barrier races do not require nominations.

If a horse is accepted, but the race is subsequently cancelled due to a lack of any other nominations, or for any other reason, the owner will receive an email and he will be refunded.

Championship races are by invitation only and require no payment in nomination fees from owners, although substantial amounts of prize money are available in these races.

Barrier races are essentially training gallops which offer no stakes money and require no nomination fees for participation. There are many different types of stakes races. Each type of stakes race has a different set of conditions, restricting the entrants according to their previous results, their sex or their age.

The operator hosts a season-ending championship day three times a calendar year. The championship day consists of six championship races for two-year olds, six championship races for three year-olds, and six open championship races for three and four-year olds. These include championship races specifically for male horses and corresponding events for fillies, and championship races for dirt and turf. These races will take place over a variety of distances as well. All championship races are by invitation only, and will all carry added money to the purse. Invitations are made to those horses that have performed best in the qualifying stakes races. All horses that wish to qualify for a championship race must be championship candidates. This simply entails a one-time payment of a supplementary fee.

Payment of a supplementary fee is the first step towards a horse's participation in a championship race. The supplementary fee ensures that a horse is registered as a championship candidate. It only has to be paid once, and allows that horse to participate in any qualifying stakes race during the course of its career, provided that horse satisfies the conditions for that qualifying stakes race. An owner has the option of paying the supplementary fee at the point of purchase of the horse in the sales ring. This option is cheaper than paying the fee at a later point in time. A supplementary fee paid later is more expensive and can be paid prior to any qualifying stakes race.

In order for a horse to be invited to participate in one of the championship races it must first enter qualifying stakes races. In order to enter any qualifying stakes race a horse must be a championship candidate. To register as a championship candidate, the supplementary fee must first be paid for that horse. For each championship race there will be a corresponding series of ten qualifying stakes races, taking place in the four calendar months (or one virtual year) leading up to the championship race day. These qualifying stakes races will take place over the same distance, the same racing surface (though not necessarily the same track going) and under the same conditions as that championship race. Qualifying stakes races are like other stakes races, in that there are restrictions and conditions that determine which horses can participate. Horses that are eligible for these races will earn championship points based on their performances (in addition to stakes money). The 14 horses that have earned the most points out of those ten corresponding qualifying stakes races will be invited to the championship race.

A member's monthly subscription fee includes the cost of feed for his horse for that month. The horse will be fed and stabled. The horse's strength and fitness can be seen by looking at the horse's gauge, which measures the current fitness and condition of that horse. An owner can alter this gauge by training his horse in barrier races and entering it in races. The owner can also purchase feed supplements that will have a randomly generated effect on his horse. All of these actions will boost the gauge, but owners must be extremely careful not to over-train, over-race, or over-feed their horse. If they do, the gauge will reflect this by reverting to a far lower level of fitness and strength for the horse. Only owners can see the gauge.

A training gallop against one other horse, used to ascertain a horse's ability over a specific distance, track type or track condition is referred to as a barrier race. The other horse that competes in a barrier race is selected by the owner from a drop-down of options for age and sex. This other horse will always perform at the average level for the selected age and sex. Therefore, this other horse acts as a benchmark for owners to rate their own horse. Owners are entitled to race their horses in as many barrier races as they wish, and unlimited barrier races are included in the monthly subscription fee. However, a barrier race affects the fitness and strength of a horse. Up to a certain point, galloping a horse in barrier races will improve its conditioning, but there is always the danger is that an owner will over-condition his horse.

On a manage horse page, there is a button called ‘barrier races’. Clicking this button will direct a member to a barrier race page. On this barrier race page, an owner can choose a horse to run a barrier race against, and click ‘run barrier race’ to start the race.

Barrier races are the most important training tool that an owner possesses. Barrier races not only enable owners to work out the strengths, weaknesses and overall ability of their horse, but they are also a way of improving a horse's overall condition. Of course, too many barrier races can have the opposite effect of over-training. However, participating in a barrier race is the best way of finding out how whether a horse is suited to dirt or turf, whether it runs better with blinkers on or off, what track conditions it runs best on, and whether the horse performs better with steel or aluminium shoes.

Barrier races are not stakes races. They carry no purse, therefore, there is no prize money to be won.

When an owner purchases his horse, his horse's gauge is at 50%. The gauge is a reading of the horse's overall fitness or condition at that specific point in time. The gauge is affected by racing the horse in all types of races, including barrier races, stakes races and championship races. Each time an owner races his horse, the fitness of his horse will improve up to a certain point. However, owners can also over-race their horse. This is known as over-training (when the gauge goes over 100%), and will cause the gauge to drop appreciably. Feeding the horse vitamin supplements will also improve the fitness of the horse, represented by a rise in the gauge. Once again, though, owners must be careful not to over-feed on vitamins. This would also qualify as over-training (causing the gauge to go over 100%), and the gauge will drop significantly.

If the gauge drops because of over-training, the drop is only temporary, and if racing and feeding resumes, the gauge will start to rise again. No horse will be at peak fitness all of the time. Owners must strategically plan their horse's campaign so that its fitness levels are high at the right time (before an important race).

“Tack” is the name given to the equipment used in a race. A tack shop page is provided on the website where owner's can buy equipment such as blinkers and aluminium shoes, products such as feed supplements and services such as gelding services that they need to get the ultimate performance from their horse.

The tack shop can be accessed in two ways. An owner can select one of his horses on the manage a horse page. The owner can then click on the vet, farrier or equipment buttons to be taken to a page which shows the products that he owns in each category, as well as the tack shop products available in each category. The owner can purchase tack shop items from here. Alternatively, the owner can click on a visit tack shop button on the left hand navigation bar, to be taken to the tack shop. From here, the owner can click on a category to be taken to the product page for that category, and add items to his basket.

A products applied table will show the owner the products that have already been applied to that horse. The products available table are the products that an owner purchased from the tack shop, but not yet applied to a specific horse. To apply a product to a horse, the owner can click on an apply this product button. These products will then show up on the products applied table, and will be immediately applied to that horse.

In order to stop applying a product from a specific category for a horse, an owner can select the relevant horse by clicking on a manage horse button on the left hand navigation bar, or on his personalised home page. He will be taken to the manage horse page for that horse. On this page, there are three buttons that correspond to the categories of products—Vet, Farrier and Equipment. Clicking on the button that represents the category that the owner is interested in, will direct him to a “manage products” page for the category chosen. To stop “applying” a product, a member can click on a remove button in a “remove product” column of the products available table.

Blinkers and alumites can be unselected in this way. The vitamin food supplement is purchased on a monthly basis and will automatically be unselected from the products applied table once the supply is depleted. A service of gelding to a colt cannot be unselected, as it is irreversible.

Each product and/or service that is available in the tack shop has potential benefits for a horse in that they enhance performance in races. The extent of that benefit depends on the predetermined characteristics of the horse. For example, the horse may improve significantly with the addition of alumites, or they may make only a slight difference. Owners need to gallop their horses in barrier races and race their horses in order to ascertain the effects of these products. Each horse is unique and will respond differently to different products.

Different products last different lengths of time. Blinkers, for example, last for the duration of that horse's career. They only need to be purchased once for any one horse, and then one always has the option to race that horse with blinkers on or off. Gelding is also a service that only needs to be purchased once for any one colt, and when applied it lasts for the duration of that colt's life on the site. Other products such as vitamin food supplements and alumites last for one month from the time of application, and can therefore, be purchased in one month units. Owners can purchase more than a single month's supply at any one time.

Currently members can place a win bet, a place bet or an each-way bet on any one race. Members can also wager on multiple races by taking a pick 3, pick 4 or pick 6. It is envisaged that more exotic bets such as exactas, trifectas and quenelles will be available in the future.

Members can place a bet from anywhere on the website by clicking on a “view race schedule” button on the left hand navigation bar, or a “place a bet” button on the home page. Once clicked, members will be directed to a race schedule page, which shows race details for all upcoming races. The race schedule defaults to the current day, but using filter options, members can change the race details that are shown. To see the details of any race, and the participating horses, member can click on the name of the race in the race schedule, to get to a race details page. To place a win or a place bet, members can click on the “view digitote” button at the bottom of the race details page. Members will be directed to a digitote page for win and place bets, which shows the odds for each horse in the race. On the digitote page, members can tick the horse(s) they would like to place a bet on, and enter the bet amount. By clicking on “submit” at the bottom of the page the bet is submitted. Members will have to pay for the bet from their basket before the bet is confirmed.

Pick x's are a type of multi-race wager in which the winners of all the included races must be selected. The most common forms of this bet on the web site are the pick Three, the pick Four and the pick Six.

The “digitote” table is a display which reflects up-to-the-minute odds for all horses in a given race. The digitote shows win and place odds, already adjusted for the takeout from the pools.

Betting for any given race closes exactly 5 minutes before that race is run. If members attempt to place a bet after this time the wager will not be accepted. Members must place bets more than 5 minutes before the off time of that race.

A member can check his betting history by simply clicking on a “view betting history” button located under a “betting” heading on the left hand navigation bar, or, if logged on, the view betting history button on the home page under “starting points”. Both buttons link members to a betting history page. On this page, a detailed table of past bets are displayed.

All horses' past performances will be available in a form guide. This guide can either be accessed for an individual horse, where users can see that horse's entire racing history, or the guide can be accessed for a specific race, where users can see the previous 3 performances for each horse in that race.

There is a wealth of information and statistics on each horse's past performances in stakes races. As with real horseracing, bettors who study this form are at an advantage. The past form will give some indication as to how well suited the horse will be to the conditions of its next race. As with real horseracing, form is never a guarantee for future performances. Owners of horses will have access to certain aspects of form that no one else has access to. This includes the results of that horse's barrier races and the overall well being of that horse (gauge). Even with this additional information, there is a random element to each race which cannot be predicted by anyone, and which guarantees a level of uncertainty for each race. However, studying the form for each horse, and interpreting how past performances may be relevant to future performances, will provide both bettors and owners with a great deal of important information.

From the race schedule page, a member can select the race that he wishes to see form for. A member will then will be taken to the race details page that displays the details for that specific race. Underneath the list of participating horses is a “compuform” button. This button allows members to view the recent form of every horse in that race.

If an owner of a horse wishes to see form for his horse, he is able to access this form from the manage horse page by clicking on a form button. If a member wishes to see specific form, he can access this by going to the race details page and clicking on the name of a specific horse in that race. He will be taken to the horse's details page for that and from here he simply clicks on the form button.

The “digiform” is the operator's version of a form guide in real horseracing. All past performances of every horse is available in a form guide. This guide can either be accessed for an individual horse, where members can see that horse's entire racing history, or the guide can be accessed for a specific race, where users can see the previous 3 performances for each horse in that race.

Members simply click on “view race schedule”, located under the race viewer heading on the left hand navigation bar, and in the top right hand corner of every page to view a race; members choose a race from the race schedule to get to the race details page, and click “view race”.

When a member misses a race, he can click on a “view race schedule” button, located under a race viewer heading on the left hand navigation bar, and in the top right hand corner of every page; choose a race from the race schedule to get to the race details page, and click a “view race” button.

In order to purchase credits one must go to the ‘cashier’. All credits must be purchased with a credit card. There is a minimum initial deposit specified.

Members can cash in credits. All they have to do is go to the “cashier” and withdraw credits from their account. These credits will be refunded to their credit card, unless the amount of credits withdrawn exceeds the amount that members originally purchased. If this is the case, then a cheque for the balance will immediately be posted to members. Members must have a minimum specified balance in credits in order to cash in.

At any stage, if a current credit balance is greater than the minimum required, all members need to do to cash in their winnings is to click on a cashier button on the left hand navigation bar. On a cashier page, they just click a cash in button.

Credit card details are encrypted and securely stored on a server.

If members are logged onto the web site, they can update their credit card details by clicking on the update registration button on the home page. This button links members to the update registration page, which allows them to update their credit card details.

Members can view their account details. To do this they click on “view account history”, located under the cashier heading on the left hand navigation bar, or access it from the cashier page.

Account history is divided into total credits gained and total credits cashed in. The difference between the two gives a member his current balance.

If a member is logged onto the web site, there is a current credits box on every page. This box displays the number of credits a member currently has in his account. For a more detailed breakdown of account transactions, members can click on the cashier button on the left hand navigation bar.

It is envisaged that races, the results of races, bloodlines, sales information and any other information relating to the game can be transmitted over a television network including satellite television networks and the like. Instead of using the Internet and a personal computer, members can use telephone networks to submit all information. Information can then be submitted orally or in writing by facsimile or the like.

1. Gaming apparatus comprising storage means for storing a number of computer generated racing objects, each racing object having inherent attributes; receiving means for receiving racing object race performance influencing information before the start of a race; and computing means for simulating a race between at least two racing objects and computing an outcome of the race using at least one of the group consisting of at least some of the race performance influencing information received and the inherent attributes of the racing objects.

2. Gaming apparatus as claimed in claim 1 in which the inherent attributes are randomly generated by the computer means.

3. Gaming apparatus as claimed in claim 1 in which the inherent attributes of one racing object is computed from the inherent attributes of two other racing objects.

4. Gaming apparatus as claimed in claim 3 in which the inherent attributes of a racing object is further computed from a previous racing performance history of the two other racing objects.

5. Gaming apparatus as claimed in any one of the proceeding claims in which race condition information computed by the computing means before a race has an influence on the outcome of a race.

6. Gaming apparatus as claimed in claim 5 in which the race condition information is randomly generated by the computing means.

7. Gaming apparatus as claimed in claim 5 or 6 in which the race condition information includes track condition information or weather condition information.

8. Gaming apparatus as claimed in claim 5 or 6 in which the race condition information includes one of the group consisting of: a length of a race; or a track type of a race; or a track going factor of a track.

9. Gaming apparatus as claimed in any one of the preceding claims in which the computing means simulates races at predetermined times.

10. Gaming apparatus as claimed in any one of the preceding claims in which the racing object race performance influencing information includes at least one of the group consisting of: information relating to equipment used by a racing object in a race; information relating to special equipment used by a racing object in a race; a previous training frequency of a racing object; a previous racing performance of a racing object; a previous training performance of a racing object; or feed supplements used by a racing object.

11. Gaming apparatus as claimed in any one of the preceding claims in which at least some of the race performance influencing information enhances or suppresses the inherent attributes of a racing object.

12. Gaming apparatus as claimed in any one of claims 1 to 10 in which at least some of the race performance influencing information is used by the computing means to compute a performance index for a racing object.

13. Gaming apparatus as claimed in claim 12 in which the performance index is computed from at least one of the group consisting of: previous training performance of a racing object; previous training frequency of a racing object; previous racing frequency of a racing object; previous racing performance of a racing object; an amount of feed supplements used by a racing object.

14. A Gaming apparatus as claimed in any one of the preceding claims in which an outcome of a race is computed from at least some of the race influencing information, the inherent attributes of a racing object and at least one of the group consisting of: a performance index for the racing objects; race conditions for a race; a random performance factor assigned to each racing object for a race; or inter-related influences that two or more of the group consisting of: the race performance influencing information; race conditions for a race; a random performance factor and inherent attributes, have on each other.

15. Gaming apparatus as claimed in any one of the preceding claims in which the inherent attributes includes at least one of the group consisting of: a randomly generated innate ability rating; a stamina rating; a sex rating; an alumite rating; a blinker rating; or a track rating.

16. A gaming method comprising the steps of:
storing a number of computer generated racing objects, each racing object having inherent attributes;
receiving race performance influencing information before the start of a race;
simulating a race between at least two racing objects; and
computing an outcome of a race using at least some of the race performance influencing information received and the inherent attributes of the racing object.
